(19) United States
(12) Patent Application Publication
(10) Pub. No.: US 2007/0146536 A1
(43) Pub. Date: Jun. 28, 2007

(54) Camera with light detection means

(75) Inventor: Michel Marie Rene Clotaire Lemoine, Chalon sur Saone Cedex (FR)

Correspondence Address: Kathleen Neuner Manne;Eastman Kodak Company, Patent Legal Staff, Rochester, NY, 14650-2201, US

(73) Assignee: EASTMAN KODAK COMPANY, Rochester, NY (US)

(21) Appl. No.: 10/575,325

(22) PCT Filed: Oct. 15, 2004
(86) PCT No.: PCT/EP04/11593

§ 371 Date: Apr. 10, 2006

(30) Foreign Application Priority Data
Oct. 24, 2003 (FR) 03/12431

(51) Int. Cl. H04N 5/235

(52) U.S. Cl. 348/362

(57) ABSTRACT

The invention relates to a device for detecting, at a given moment, a light difference between two light detection elements. The invention has application in the technical field of imaging, and more particularly in cameras comprising the invention device. The invention describes a device for detecting a light variation between two locations (20, 21, 22) placed on one surface of a camera body (23) and calculating a corresponding difference. The camera comprises light measuring cells (1C, 2C, 3C) arranged regularly around the viewer (20), the flash (21), and the lens (22). A light differential existing between two locations, for example between the viewer (20) and the lens (22), automatically generates a calculation of this light difference, to compare it with a set or reference value (Vr). A warning device linked to the invention device is activated if the light difference exceeds the set value (Vr).

### FIELD OF THE INVENTION

The invention is in the field of light variation detection. The invention has application especially in the technical field of imaging. The invention relates more specifically to a device to detect, at a given moment, a light variation in front of the lens or in front of the flash window of a camera, and to warn the user of this variation.

### BACKGROUND OF THE INVENTION

In the imaging field, the well-known problem of the photographer's finger placed in front of the camera lens at the moment of taking the shot has already been solved by various means.

U.S. Pat. No. 3,878,548 describes mechanical means incorporated in a camera. These means enable, before exposure of the film, the prevention, by warning the photographer, of a finger from being placed in front of the objective. The means enable the shutter opening button to be locked, and enable the photographer to be warned visually, by moving a flag type element in the viewer. A disadvantage linked to these means relates to the relative movements of the various components (rods, springs, and pins) which can produce problems of operational reliability in use. The finger, placed in front of the lens, must touch by contact a mechanical element of the sliding shutter placed in front of the lens. Consequently, these means have the additional disadvantage that when a finger is placed in front of the lens, without touching the camera, this finger cannot operate the mechanical means of locking and warning.

U.S. Pat. No. 4,866,470 describes a camera having a lens not projecting in relation to the front of the camera. This camera comprises tactile means of the type: projections, notches, specially profiled projections, and added to the surface of the lens. These tactile means are placed on the front of the camera, around the lens, to warn the photographer by touch, when their fingers get close to the lens. Besides the fact that the unwarned photographer does not necessarily know what these means are for, and besides the fact that they can be seen as not aesthetic or unpleasant, a disadvantage of such means is that if a finger is not placed pressing on the surface of the front of the camera, but is placed for example slightly set off from this surface, the photographer is not warned that their finger is in the field of the lens.

U.S. Pat. No. 5,210,560 describes a camera that comprises photosensitive sensors placed near the lens or near the flash emission window. These sensors comprise emission and detection means, for example infrared, to emit light radiation in the direction of a photographer's finger that might, inadvertently, be positioned near the lens or flash. The sensors also comprise means to detect the reflection of the light radiation by the finger. Means of warning, for example of the electroluminescent diode (LED) type, are connected to the photosensitive sensors, so as to warn the photographer, if for example one of their fingers is badly placed in relation to the lens. These means imply that the detected finger passes just over the location of the photosensitive sensor. They do not guarantee an absolute detection in every case, according to the way the camera is held. That is to say that a finger positioned for example opposite the detector, this in relation to the lens, cannot be detected, because this finger is placed simply a little bit too far from the detector, while this finger nevertheless blocks the lens.

U.S. Pat. No. 5,943,516 describes a camera provided with capacitive detectors or current detectors. These detectors enable, for example when a photographer's finger is badly positioned in front of a camera window, like the flash window, an electric parameter change to be generated by means of an electric circuit linked to the detection elements. This enables a visual alert (LED) or sound to be activated, which warns the photographer that one of their fingers is blocking the window. The alert device works from finger contact on a detector; and the device has the disadvantage of not working if the finger is placed for example in front of the window, without touching it.

U.S. Pat. No. 6,351,606 describes an electronic or digital camera and a method to detect the obstruction, for example by a photographer's finger, of the window of the camera's electronic flash. The described means determine, after a shot using the electronic flash, the signal levels of the image pixels data, and then calculate whether the sensor CCD (Charge Coupled Device), connected to a signal level determination unit, is under-exposed. If it is determined that the electronic flash does not fully emit the quantity of light, then a processor concludes that a finger is blocking the flash window. In this case, an alert displays this obstruction, so as to prevent the emission of the flash. The problem of the failed picture, when a finger is placed in front of the lens during the shot, is experienced in an even more damaging way by the user of a silver process camera enabling a film to be exposed, because the anomaly will generally only be found after the development operation. This problem is not taken into account in U.S. Pat. No. 6,351,606.

US Patent Application 2003/0012570 describes a camera that is provided with electromechanical means enabling the presence of a photographer's finger in front of the shutter to be detected. These means detect the presence of the finger from the moment when the finger touches a shutter lens. In particular they comprise electrodes and an oscillator to enable the phase differences of high frequency pulses, caused by a capacitance change of the electrodes, to be detected. These electromechanical means are of a limited efficiency, because the photographer's finger has to touch for example the shutter lens to generate a capacitance change. If the finger is simply placed in front of the lens, without touching the shutter lens, the electromechanical detection means do not work.

### SUMMARY OF THE INVENTION

Invention finds its application in particular for recording devices, of the type for example still camera or moving picture camera. The invention relates to the means to calculate, at a given moment, a light difference between two light detection elements placed on the camera body. The aim of the invention is to eliminate the above-mentioned disadvantages of the previous art, which describe means that do not enable, due to their design or due to their location on a camera, the presence of an obstacle, for example a photographer's finger, placed in front of or in the field of the camera lens to be systematically reliably detected. The lack of reliability of the means of the previous art is due to the fact that if a finger is placed in the shot field and does not touch (in a tactile way) the camera lens, or if the finger is placed a little bit too far from the detection means, then it is not recognized by these detection means.

It is also an aim of the invention to prevent expensive and qualitatively unsatisfactory operations for the photographer. These operations result from the taking of one or more photographic shots that will for example show a finger on the photographic paper after development, or an underexposure of the film if a finger is placed in front of the flash, in the case of a flash camera. Very often, for example on a camera, a viewer and separate lens are found. Furthermore, camera sizes are increasingly compact; consequently, the problem of the finger placed in front of the lens should be taken into account reliably, in particular when the photographer holds the camera vertically: it is in this position (taking vertical photos), with a modest sized camera, that the risks of placing a finger in front of the lens are greater. In other words, the problem of the finger placed in the shooting field is accentuated with the camera held vertically to take high direction shots. On the other hand, camera ergonomics and dimensions are normally planned for holding this camera in a horizontal position. Now, these two camera positions, horizontal or vertical, for the same photographer, generally generate different finger positions when holding the camera; and these finger positions in relation to the camera are generally mastered less well, when the photographer holds the camera in a vertical position.

Consequently, and contrary to the means of the previous art, the invention enables a better response to the problem of a finger placed for example in front of the camera lens, by systematically detecting any unusual presence of one (or more) objects placed anywhere in a camera's shooting field, and this whether or not this object touches the camera.

It is an aim of the invention to be able to be used in any type of still camera or motion-picture camera, independently of the geometry of the camera body, invention can be for example incorporated into a camera provided with a projecting lens or into a camera having a non-projecting lens. The invention thus has the advantage of being able to be incorporated easily into any camera, without any particular locating restrictions.

The aim of the invention is therefore to increase the detection reliability of the presence of an object, for example a finger, in front of a camera lens, independently of the position (horizontal or vertical) in which the photographer holds the camera, during a shot, and whatever the shape of the camera body. The detection reliability of an object, in relation to the previous art, is greater, whatever the relative position of the object in front of the lens. In other words, whether this object is for example in contact with the camera or whether it does not touch the camera, the invention device enables the photographer to be warned before taking the shot.

It is also an aim of the invention not to use mechanical elements, because the movements of these elements, located inside and/or outside the camera body, risk producing operating noises, or risk generating malfunction risks, of the locking or jamming type, that compromise reliability.

The invention device enables the above-mentioned disadvantages to be eliminated. The object of the invention is a camera comprising a device with at least two light detection elements. These light detection elements are connected to a threshold comparison means, and a warning device controlled by the comparison means emits a warning, if, at a given moment, a light difference between two light detection elements exceeds a set value.

The light detection element comprises at least one light measuring cell.

The light measuring cell comprises a capacitance element, a resistance element, a photodiode, an amplifier and an output. The cell enables a quantity of light received by this cell to be transformed into an electric parameter, in the output of said cell.

In a first embodiment of the invention, the camera also comprises a summing means connected between the light measuring cell and the threshold comparison means.

The threshold comparison means is for example a comparator with operational amplifier, or, in a variant, the threshold comparison means comprises a comparator connected to a computer.

In a second embodiment of the invention, the threshold comparison means comprises a multiplexing unit connected to an analog-to-digital converter, and to a computer unit. Advantageously the computer unit is a microprocessor.

The invention device comprises a warning device that is selected in the group comprising light, and/or sound, and/or mechanical warning devices. The warning device is for example one or more electroluminescent diodes placed inside the viewer. Or, the warning device is audible: for example a buzzer.

The invention device is used advantageously with a camera comprising a lens, a viewer, and a flash. Each light detection element comprises at least one light measuring cell. In a preferred embodiment, the camera is characterized in that the first light detection element comprises two light measuring cells arranged around the viewer, the second light detection element comprises eight light measuring cells arranged around the lens, and the third light detection element comprises two light measuring cells arranged around the flash. The light measuring cells can be arranged regularly, respectively around the respective perimeters of the viewer, lens and flash.

The invention device enables, at a given moment, light variation, for example between two different places arranged on a camera body, to be detected and then a difference corresponding to this variation to be calculated. These two locations are, for example, the zone corresponding to the viewer location, placed on the front of the camera body, and the zone corresponding to the lens location, also placed on the front of the camera. If an object, for example a finger or part of finger, is positioned in the field of the shooting lens, by touching or not touching this shooting lens, a light variation is detected, a difference is calculated, and a comparison of this differential with a set or reference value enables a visual and/or sound warning device to be activated to warn the photographer. The set value corresponds to a totally free shooting field, i.e. not blocked by the presence of an object disturbing the quantity of ambient light near the shooting lens.

The light detection elements of the invention enable, at a given moment, for example just before the shot, on the one hand the ambient light around the viewer to be measured, and on the other hand, the ambient light around the lens or flash to be measured. And this, independently of whether the object (a finger), placed in the lens or flash field, touches or not these light detection elements. The device of the present invention also has the advantage of being able to detect the location, on the camera, where the disturbing object is: for example, in front of the lens, and/or the flash.

Other characteristics and advantages of the invention will appear on reading the following description of the embodiments, with reference to the drawings of the various figures.

### BRIEF DESCRIPTION OF THE DRAWINGS

FIG. 1 schematically represents a first embodiment of the device according to the invention.

FIG. 2 schematically represents a second embodiment of the device according to the invention.

FIG. 3 schematically represents a third embodiment of the device according to the invention.

FIG. 4 schematically represents a light detection cell of a light detection element according to the invention.

FIG. 5 schematically represents the front of a camera according to the invention.

### DETAILED DESCRIPTION OF THE INVENTION

The invention is described with reference to preferred embodiments.

The following description is a detailed description of the main embodiments of the invention, with reference to the drawings in which the same numerical references identify the same elements in each of the figures.

The invention device is intended to be located for example on a camera. The front of the body 23 of this camera comprises, according to FIG. 5, a viewer 20, a shooting lens 22, and a flash 21 as an option.

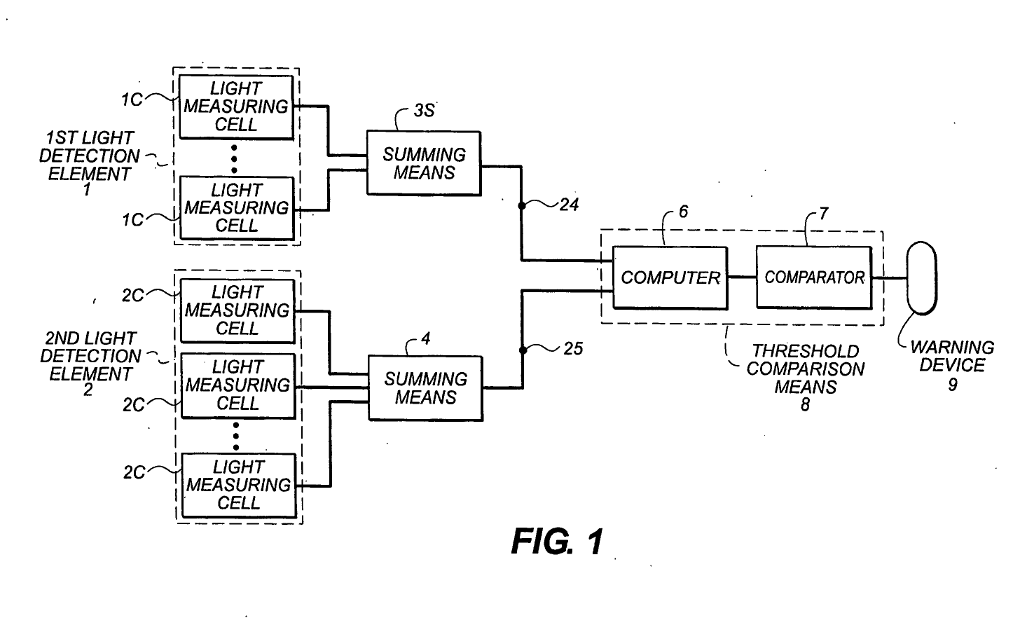

FIG. 1 corresponds to a first embodiment of the invention device, intended to be located for example on a camera not comprising flash. The invention device comprises a first light detection element 1. This first element 1 comprises a set of light measuring cells 1C, independent one from another. These light measuring cells are independent, i.e. they operate by producing, independently one from another, the electrical parameters data that is specific to them. The light measuring cells 1C are placed for example on the front of the body 23: they are preferably arranged regularly around the viewer 20. The invention device also comprises a second light detection element 2 comprising a set of light measuring cells 2C independent one from another. According to FIG. 5, these light measuring cells 2C are placed for example on the front of the body 23, and are preferably arranged regularly around the lens 22. The elements constituting the light measuring cells 2C are advantageously identical to the elements constituting the light measuring cells 1C. In another embodiment, the light measuring cells 1C, 2C may not be arranged regularly around these perimeters.

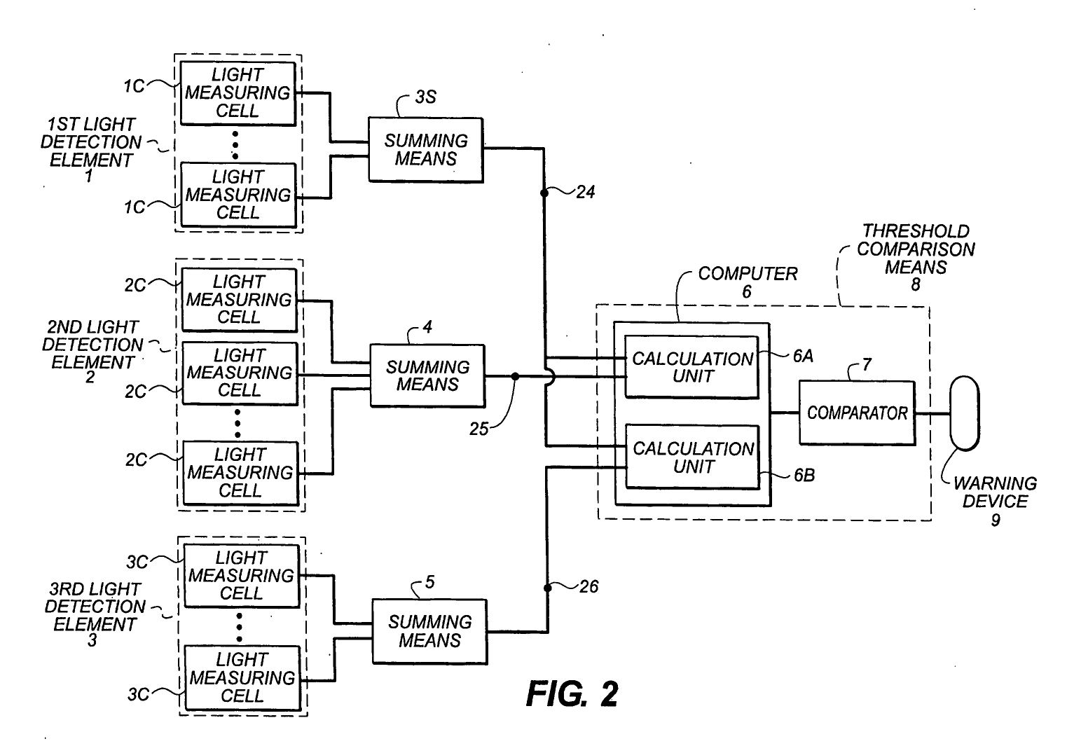

FIG. 2 corresponds to a second embodiment of the invention device, intended to be located for example on a camera whose body front 23 comprises, according to FIG. 5, besides the viewer 20 and the lens 22, a flash 21. The device according to this second embodiment comprises a third light detection element 3. This third light detection element 3 comprises a set of light measuring cells 3C, independent one from another, placed for example on the front of the body 23, and preferably arranged equally around the flash 21. The elements constituting the light measuring cells 3C are advantageously identical to the elements constituting the light measuring cells 1C and 2C.

According to a preferred embodiment of the invention, and according to FIGS. 2 and 5, the first light detection element 1 comprises two light measuring cells 1C, placed and arranged regularly or uniformly around the perimeter of the viewer 20. The second light detection element 2, comprises eight light measuring cells 2C, placed and arranged regularly around the perimeter of the shooting lens 22, and the third light detection element 3 comprises two light measuring cells 3C, placed and arranged regularly around the perimeter of the flash 21. If the lens 22 has for example a circular shape, eight light measuring cells 2C are arranged regularly around the perimeter of this lens, this means that two consecutive cells form together, according to FIG. 5, an angle a of 45 degrees. In another embodiment, the light measuring cells 1C, 2C, 3C may not be arranged regularly around these perimeters.

Besides the previously described embodiments, the camera can take, in general, light detection elements (1, 2, 3) each comprising at least one light measuring cell (1C, 2C, 3C).

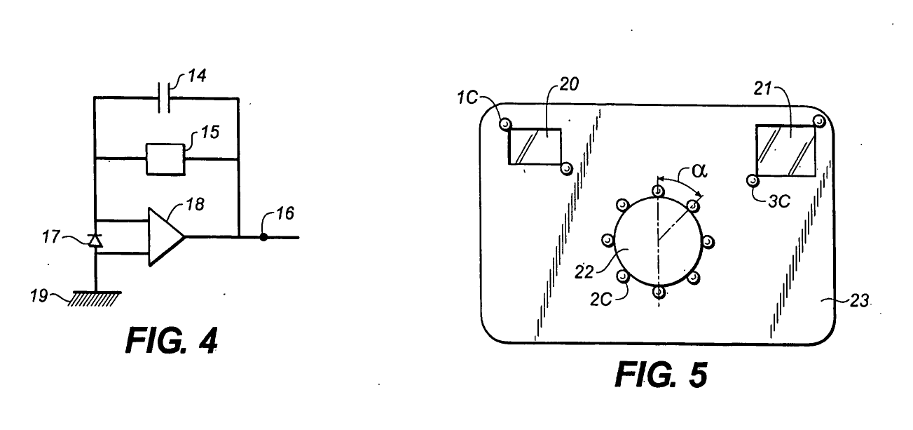

According to FIG. 4, each light measuring cell 1C, 2C, 3C preferably comprises a capacitance element 14, a resistance element 15, an output 16, a photodiode 17, and an amplifier 18 referenced to the ground 19. The function of the photodiode 17 is to transform incident light radiation, for example due to the ambient light, received by this cell, into an electric current, and which thus becomes an analog value, the voltage at the output 16 of the light measuring cell 1C, 2C, 3C. Consequently, a variation of this incident light on the photodiode 17 generates a variation of output current 16. For each of the light measuring cells 1C, 2C, 3C belonging to the same light detection element 1, 2, 3, the gains of the amplifiers 18 are identical. Because of the capacitance 14, the amplifier 18 is also a low-pass filter, for example having a cutoff frequency of 10 Hertz. This frequency of 10 Hertz is chosen to avoid, if necessary, the influence of lighting lamps surrounding the invention device. The resistance 15 enables the conversion gain of the current flowing in the photodiode 17 to be adjusted in voltage.

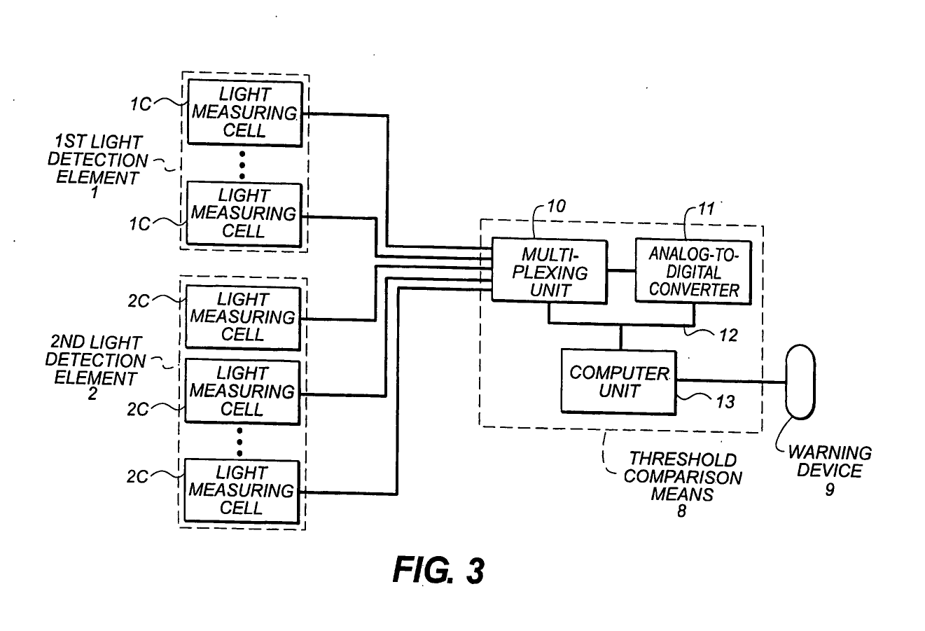

According to the embodiments of FIGS. 1 and 2, each of the light measuring cells 1C, 2C, 3C is connected to a summing means 3S, 4, 5. In a first embodiment of the invention, according to FIGS. 1 and 2, this summing means is connected to a threshold comparison means 8. The threshold comparison means 8 is, for example, a comparator with operational amplifier. But, according to FIGS. 1 and 2, this threshold comparison means 8 can also be a comparator 7, connected to a computer 6. In a variant, the summing means 3S, 4, 5 are incorporated into the computer 6 or the comparison means 8. According to FIGS. 1 and 2, the threshold comparison means 8 enables analog processing to be performed of the electrical parameters values (voltage) transmitted to the outputs 16 of the light measuring cells 1C, 2C, 3C. In other words, the comparison means 8 enables algebraic operations among the values of the electrical parameters to be executed automatically. The comparison means 8 thus enables the values of the voltage induced respectively at the outputs 16 of each light measuring cell 1C, 2C, 3C of the light detection elements 1, 2, 3 to be added automatically to obtain a sum Vi, respectively at points 24, 25, 26. Every light detection element 1, 2, 3 induces a sum Vi specific to said element. The index “i” is an integer that varies for example from 1 to 2 for the embodiments of FIGS. 1 and 3, which comprise two light detection elements 1 and 2. The index “i” varies for example from 1 to 3 for the embodiment of FIGS. 2, which comprises three light detection elements 1, 2, 3. The threshold comparison means 8 also enables to automatically subtract from them, the respective sums Vi thus obtained at points 24, 25, 26. These sums Vi correspond respectively to each of the electrical parameters values, and the sums Vi are specific to each of the light detection elements 1, 2, 3. For a given light detection element, Vi represents the sum of the individual analog values produced at the outputs 16 of the light measuring cells 1C, 2C, 3C. In this embodiment, the unit for measuring the electrical parameters is the “volt”. If the elements 14, 15, 17, 18 which form the light measuring cells 1C, 2C, 3C are not identical among the various cells, the device is adjusted, so that the sum of the respective voltages Vi, measured at points 24, 25, 26, is the same at these three points 24, 25, 26. This adjustment is operated when there is no object disturbing the incident ambient light on the set of light detection elements 1, 2, 3.

The threshold comparison means 8 is connected to a warning device 9. This warning device 9 is visual and/or audible. The warning device 9 can be activated visually and/or audibly by the comparison means 8. In a preferred embodiment of the invention, the warning device 9 comprises, for example, one or more electroluminescent diodes (LED) that are placed in the viewer window, so as to be visible to the photographer's eye, when the latter prepares to take a photograph. But the warning device 9 can also be an audible element, for example a buzzer incorporated into the camera. This buzzer can, for example, be connected to the LEDs 9, to operate (to be activated) simultaneously with the LEDs 9, or not connected to said LEDs, and to operate independently of them.

In a second embodiment of the invention, according to FIG. 3, the threshold comparison means 8 comprises a multiplexing unit 10 connected to an analog-to-digital converter 11 to communicate, via a data transport element 12, with a computer unit 13. The multiplexing unit 10 is connected to the outputs 16 of the light measuring cells 1C, 2C, 3C, and enables the individual values of the electrical parameters at each of these outputs 16 to be collected. The summing means of the output data of the light measuring cells 1C, 2C, 3C can be integrated either into the multiplexing unit 10, or into the computer unit 13. The data transport element 12 is for example a bus connected between on the one hand the multiplexer 10—converter 11 assembly, and the computer unit 13 on the other hand. The computer unit 13 is, for example, a microprocessor. According to the embodiment of FIG. 3, the comparison means 8 enables a conversion of the voltage analog data to be made into digital values. The comparison means 8 of the embodiment of FIG. 3 thus enables digital processing of the voltage parameter values Vi produced at points 24, 25, 26 to be performed. The voltage parameters Vi come from the summed individual data, previously produced at the outputs 16 of the light measuring cells 1C, 2C, 3C. In other words, the comparison means 8 enables algebraic operations among the analog data to be executed automatically after they have been converted into digital values. The comparison means 8 enables, like in the previously described embodiments, individual values specific to each light measuring cell (outputs 16) to be added to obtain the summed values Vi, and to subtract from them the summed values Vi specific to each light detection element 1, 2, 3.

If there is no object in front of the viewer 20, lens 22, or flash 21, the accumulated voltage Vi at the outputs 16 of the light measuring cells 1C, 2C, 3C is for example, according to FIGS. 1 and 2, equal to a value V₁ at points 24, 25, 26: the case where it is considered, for example, that the ambient lighting is the same in front of each light measuring cell. This value V₁ is for example obtained by choosing an appropriate resistance value 15 in each light measuring cell, and this for each light detection element 1, 2, 3. Consequently, if there is no object blocking the ambient light radiation on the viewer 20, lens 22, and flash 21, the difference of the accumulated voltages Vi between the first light detection element 1 of the viewer and the other light detection elements 2, 3 is zero.

The fact that an object is positioned in front of the viewer 20, is not of much practical interest on a camera with a viewer. In this case, if for example the photographer's finger is placed in front of the viewer 20, the photographer will realize it visually, by looking through the viewer, just before taking a photograph. According to FIG. 2, the invention device enables, by using for example the specific calculation units 6A and 6B of the computer 6, to calculate the difference between the electrical parameter values (accumulated voltages Vi) between the first light detection element 1 corresponding to the viewer 20 serving as reference, and respectively the second light detection elements 2 and 3, corresponding to the lens 22 and flash 21. The values Vi, as previously described, are measured at points 24, 25, 26.

If an object is present, either in front of the flash 21, or the lens 22, the accumulated voltage of the outputs 16 of the cells of the light detection element corresponding to the flash or the lens takes for example a value V₂, different than V₁ (no object). According to FIG. 2, if the object blocks for example the lens 22, the corresponding light detection element 2 produces a voltage V₂ at the point 25; the voltages at points 24 (viewer) and 26 (flash) remaining equal to V₁ (no object). Thus, the object creates an imbalance in the relations between the voltages of each light detection element 1, 2, 3. The difference of the voltages (V₁−V₂) is thus different than zero. There is a light difference between the light detection elements 2 (lens) on the one hand, and 1 (viewer), 3 (flash) on the other hand.

The threshold comparison means 8 enables the presence of an object present in front of the flash 21 and lens 22 windows to be detected. When an object (generally a finger tip) is positioned for example in front of the second light detection elements 2 and 3, corresponding to the light measurement, respectively in front of the lens 22 and the flash 21, i.e. there is, for example, at the same moment an object (e.g. photographer's finger) placed in front of the lens 22 and also another object (e.g. another finger of the photographer) placed in front of the flash 21, the threshold comparison means 8 determines a difference between the summed value of the first electrical parameter V₁, and respectively the summed values of the other electrical parameters V₂ and V₃. This difference is produced by the calculations of the differences (V₁−V₂) on the one hand, and (V₁−V₃) on the other hand. The first value V₁ corresponds to the measurement of the light near the viewer 20; V₁ corresponds for example to the ambient light near the viewer 20. The values V₂, V₃ correspond, for example, to the measurement of ambient light attenuated near the lens 22 and the flash 21. V₂ differs from V₃ in so far as, for example, the attenuated light on the lens 22, in relation to the ambient light, is a little more or less than on the flash 21. In other words, the quantity of incident light on the lens 22 is, at a given moment, different than the quantity of incident light on the flash 21. In this example, the value V1 corresponds to a set or reference value Vr, for which there is no object in front of the light detection element 1 of the viewer 20. The preferably chosen set or reference value Vr is “zero” (Vr=0=V₁−V₁). When an object is positioned in front of another light detection element 2, 3, i.e. an object is placed for example in front of the lens 22, and this object or another object is also placed in front of the flash 21, the comparison means 8 determines a positive or negative difference between the value of the first parameter V₁ and the values of the parameters V₂, V₃. This difference, different than zero (Vr=zero=set or reference value), expresses the existence of a light difference between the zones 20 and 22 on the one hand, and between the zones 20 and 21 on the other hand; the zone 20 being chosen as a reference zone. The sign of this difference 37 plus” or “minus”) is a function of the internal arrangement of the electrical circuit components of the comparison means 8. In a preferred embodiment, and to calculate a positive difference, the programming of the comparison means 8 integrates the absolute value of the difference calculated between V₁ and V₂, or between V₁ and V₃. The formula of the difference is thus |V₁−V₂| or |V₁−V₃|.

The invention device also enables the location to be detected, for example on the camera, where the disturbing object is placed that cannot be seen by the photographer whose eye is placed in the viewer. Thus the invention device enables, for example, the detection of an object placed in front of the shooting lens 22: generally the most harmful case, in terms of the final result sought by the photographer. In this first case, the absolute value |V₁−V₂| is different than zero. The invention device also enables, for example, the detection of an object placed in front of the flash 21: not a systematically harmful case because, according to the ambient light conditions, the use of flash is not always required. In this second case, the absolute value |V₁−V₃| is different than zero.

The invention device also enables the detection of an object placed for example both in front of the shooting lens 22 and in front of the flash 21. In this latter case, the values |V₁−V₂| and |V₁−V₃| are different than zero.

Detection of the object in front of the flash 21 and/or the lens 22 is operated by a warning device 9, connected to the comparison means 8. The warning device 9 comprises for example at least one electroluminescent diode placed inside the viewer 20, so as to be visible by the photographer, when they look through the viewer 20. In a preferred embodiment of the invention, two electroluminescent diodes (LEDs) are placed in the viewer 20. On the one hand, a first diode producing for example red light, if an object is placed in front of the lens 22; on the other hand, a second diode producing orange light, if an object is placed in front of the flash 21. But the warning device 9 can also be an audible element, buzzer type, placed for example on the front 23 of the camera. It can also be planned for this buzzer to be activated in a synchronized way (i.e. operates at the same time) with the electroluminescent diodes 9.

If |V₁−V₃| is different than zero and no object is blocking the viewer 20, this means that an object is placed in front of the flash window 21. In the embodiment of the invention with flash, the comparison means 8 also enables the saving of a “flash threshold” value Vf. This value Vf corresponds to the ambient light level, around the camera, below which the flash must be put into service, otherwise the photograph is underexposed. The comparison means 8 enables the values Vf and the reference value to be compared with the ambient light, which is for example V1 in this example. If the difference between Vf and V1 is different than zero (zero is the set value Vr), and that for example Vf is greater than V1, then the flash warning device 9 is not activated: in this case, the flash is not used, because it is not considered necessary to obtain a correct photograph. The flash warning device 9 is for example the orange LED.

In the opposite case, where for example Vf is less than V1, the flash's orange LED is activated. This last case means on the one hand that the camera's flash, for example automatic, is required to obtain a correct photograph, given the level of ambient light, and that, on the other hand an object blocks the flash. The LED 9 thus warns for example the photographer that they should remove their finger that is blocking the flash 21.

In special case where the photographer's finger partially blocks for example the viewer 20, and if the photographer deliberately chooses to leave their finger in front of the viewer 20, an imbalance between the accumulated voltages Vi of each light detection element 1, 2, 3 occurs. And this imbalance occurs, whether the lens 22 and/or flash 21 are blocked or not by an object themselves. In this case, the comparison means 8 records the differences, between voltages Vi, different than zero, and the warning device 9 is activated.

1. A camera (23) comprising at least two light detection elements (1, 2, 3) connected to a threshold comparison means (8), and a warning device (9) controlled by the comparison means for emitting a warning if a light difference between two light detection elements exceeds a set value (Vr).

2. The camera according to claim 1 characterized in that the light detection element (1, 2, 3) comprises at least one light measuring cell (1C, 2C, 3C).

3. The camera according to claim 2, in which the light measuring cell (1C, 2C, 3C) comprises a capacitance element (14), a resistance element (15), a photodiode (17), and an amplifier (18) to transform a quantity of light received by the cell into an electrical parameter at the output (16).

4. The camera according to claim 2, also comprising a summing means (3S, 4, 5) connected between the light measuring cell (1C, 2C, 3C) and the threshold comparison means (8).

5. The camera according to claim 4, wherein the threshold comparison means (8) is a comparator (7) with operational amplifier.

6. The camera according to claim 4, wherein the threshold comparison means (8) comprises a comparator (7) connected to a computer (6).

7. The camera according to any one of claims 1 to 3, wherein the threshold comparison means (8) comprises a multiplexing unit (10), an analog-digital converter (11), and a computer unit (13).

8. The camera according to claim 7, wherein the computer unit is a microprocessor.

9. The camera according to any one of claims 1 to 8, wherein the warning device (9) is a warning device selected from the group comprising light, and/or audible, and/or mechanical warning devices.

10. The camera according to any one of claims 1 to 9, with a viewer (20), and with a lens (22), characterized in that the first light detection element (1) comprises two light measuring cells (1C) arranged around the viewer (20), and the second light detection element (2) comprises eight light measuring cells (2C) arranged around the lens (22).

11. The camera according to claim 10, wherein the light measuring cells (1C, 2C) are arranged regularly, around the respective perimeters of the viewer (20) and the lens (22).

12. The camera according to any one of claims 1 to 9, with a viewer (20), with a flash (21), and with a lens (22), characterized in that the first light detection element (1) comprises two light measuring cells (1C) arranged around the viewer (20), the second light detection element (2) comprises eight light measuring cells (2C) arranged around the lens (22), the third light detection element (3) comprises two light measuring cells (3C) arranged around the flash (21).

13. The camera according to claim 12, wherein the light measuring cells (1C, 2C, 3C) are arranged regularly, around the respective perimeters of the viewer (20), the lens (22) and the flash (21).

14. The camera according to any one of claims 9 to 13, wherein the warning device (9) is at least one electroluminescent diode placed inside the viewer (20).

15. The camera according to any one of claims 9 to 13, wherein the warning device (9) is a buzzer.
